(19) United States
(12) Patent Application Publication
(10) Pub. No.: US 2006/0278217 A1
(43) Pub. Date: Dec. 14, 2006

(54) Method for producing lactose from lactoserum or a permeate derived from lactoserum ultrafiltration

(75) Inventor: Marc-Andre Theoleyre, Paris (FR)

Correspondence Address: CASELLA & HESPOS, 274 MADISON AVENUE, NEW YORK, NY, 10016, US

(73) Assignee: APPLEXION, Epone (FR)

(21) Appl. No.: 10/526,885

(22) PCT Filed: Aug. 25, 2003
(86) PCT No.: PCT/FR03/02574

§ 371 Date: Oct. 7, 2005

(30) Foreign Application Priority Data
Sep. 6, 2002 (FR) 02/11046

(51) Int. Cl. C13K 5/00

(52) U.S. Cl. 127/31

(57) ABSTRACT

A method is provided for producing lactose from whey or a permeate resulting from the ultrafiltration of whey. The method includes replacing at least part of the multivalent cations of the whey or permeate by monovalent metal cations to obtain a whey or permeate depleted of multivalent cations. The method then replaces at least part of the multivalent inorganic anions and organic acid anions of the whey or permeate, by monovalent anions non-able to form complexes with the multivalent cations, this latter replacement step is carried out before or simultaneously with the replacement of at least part of the multivalent cations of the whey or permeate. The method then crystallizes the whey or permeate resulting from the replacement steps to obtain crystallized lactose and a mother liquor enriched in monovalent metal cations.

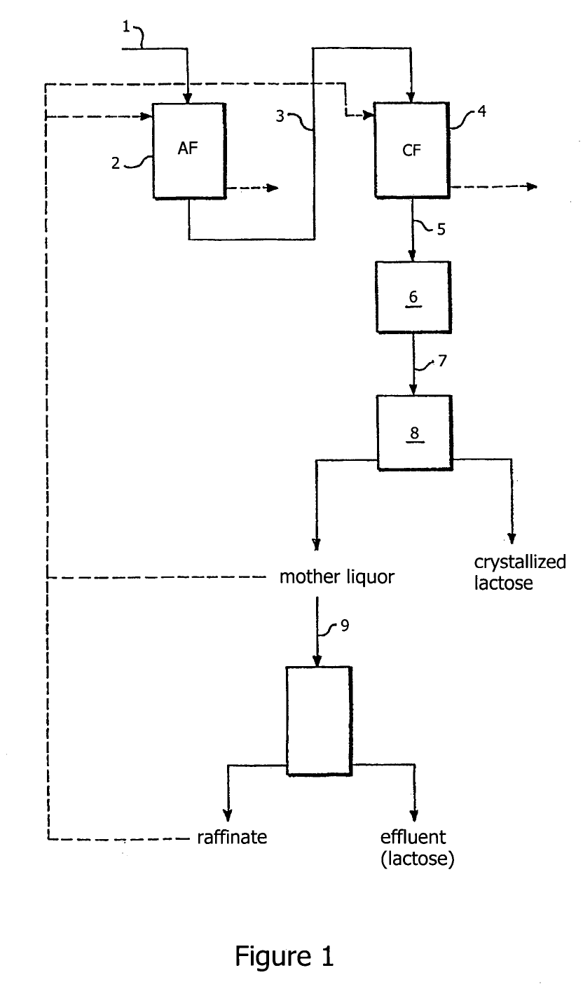

The present invention relates to a production method of lactose from whey or a permeate resulting from the ultrafiltration of whey, this whey and permeate comprising monovalent Na⁺ and K⁺ cations, monovalent Cl⁻ anions, multivalent Ca²⁺ and Mg²⁺ cations and multivalent inorganic anions such as phosphate anions and/or organic acid anions able to form complexes with said multivalent cations, such as lactate and citrate.

In such a production method of lactose, a concentration operation is usually contemplated before a crystallization operation. However, the presence in the whey or the whey ultrafiltration permeate of calcium and/or magnesium phosphate is a source of precipitations in the evaporators used for said concentration; this requires a frequent cleanup of these evaporators. Further, the precipitation of calcium and/or magnesium phosphate during the crystallization has an adverse effect on the latter.

To remedy to those problems, it was suggested in the prior art to limit the aforementioned problems by adjusting the pH of the whey or of the whey ultrafiltration permeate in order to precipitate calcium and/or magnesium phosphate, then separate the precipitated salt by centrifugation.

This technique is however costly, and the decalcification yield is limited.

The basic idea of the present invention is to carry out a crystallization operation on a whey or a permeate resuiting from the ultrafiltration of whey, treated by ion-exchange resins in order to deplete it in multivalent cations and possibly in multivalent inorganic anions and/or organic acid anions, even to substantially totally relieve it from these cations and/or anions, while producing effluents of which the nature allows for the regeneration of said resins without an outside contribution of chemicals.

Thus, the aim of the present invention is a method according to the first paragraph of this description and which is characterized in that it comprises the operations:
(a) of replacement of at least a part of the multivalent cations of the whey or permeate by monovalent metal cations such as Na⁺ and/or K⁺, in order to obtain a whey or a permeate depleted in multivalent cations,
(b) of replacement of at least a part of the multivalent inorganic anions and organic acid anions of the whey or permeate by monovalent anions such as Cl⁻ non-able to form complexes with the multivalent cations, operation (b) being performed either simultaneously to above operation (a), in which case a whey or permeate depleted in multivalent inorganic anions, in organic acid anions and in multivalent cations results from it, or before said operation (a), in which case a whey or permeate depleted in multivalent inorganic anions and organic acid anions results from it, and
(c) of crystallization of said whey or permeate depleted in multivalent inorganic anions, in organic acid anions and in multivalent cations, in order to obtain crystallized lactose and a mother liquor enriched in monovalent metal cations, this crystallization being preceded, if necessary, by a concentration operation of said whey or permeate to the desired degree.

Operation (a) above provides a whey or permeate greatly enriched in monovalent metal cations which have the advantage of not having any adverse impact on the possible concentration operation, nor on the subsequent crystallization operation (c).

As for operation (c), it produces crystallized lactose and a mother liquor containing most of the monovalent metal cations contained in the whey or permeate from operation (a).

It has actually been established that such a replacement of at least a part of the anions able to form complexes with the Ca²⁺ and Mg²⁺ cations, by monovalent anions non-able to form such complexes, such as Cl⁻, could greatly improve the decalcification yields.

It will be understood that with this replacement, the said complexes are more or less destroyed, which increases the availability of the multivalent cations (Ca²⁺, Mg²⁺) which can therefore more easily be replaced by the monovalent metal cations.

Preferably, the method according to the invention further comprises the operation:
(d) of chromatography of at least a part of the mother liquor obtained during crystallization operation (c), in order to produce a lactose-enriched fraction, and a raffinate enriched in monovalent metal cations and possibly in monovalent anions.

According to an embodiment, operation (a) of replacement of the multivalent cations preferably comprises the processing of the whey or permeate with a cationic resin of which the counter-ion is a monovalent metal cation.

Moreover, operation (b) of replacement of the multivalent inorganic anions and organic acid anions preferably comprises the processing of the whey or permeate with an anionic resin of which the counter-ion is a monovalent anion non-able to form complexes with the multivalent cations.

It will be specified that the aforementioned resins are preferably strong anionic and strong cationic resins.

Moreover, the monovalent cation forming the counter-ion of the cationic resin is preferably the Na⁺ and/or K⁺ cation(s), and the monovalent anion forming the counter-ion of the anionic resin is preferably the Cl⁻ anion.

According to another characteristic of the method according to the invention, it can further comprise the operation:
(e) of regeneration of the aforementioned cationic resin and/or anionic resin,

this regeneration being advantageously performed with a fraction of the mother liquor produced during crystallization operation (c) and/or with at least one fraction of the raffinate produced during chromatography operation (d).

It will be added that this regeneration can be performed in series or in parallel on the anionic resin and the cationic resin.

It will also be added that depending on the ionic composition of the whey or permeate, a pH adjustment of the regeneration liquid, in particular of said mother liquor, may be necessary to prevent any risk of precipitation of calcium or magnesium phosphate. Thus, this adjustment can preferably be performed by means of phosphoric acid or hydrochloric acid.

The present invention is illustrated hereafter, in a non limitative manner, by the description of a preparation example of lactose, done with reference to the unique figure which is the schematic representation of an installation for the carry-out of the method according to the invention.

The feedstock is, in the selected example, a permeate obtained by ultrafiltration of whey. Such a permeate comprises mainly lactose, organic acids and minerals (particularly Na⁺, K⁺, Ca²⁺ Mg²⁺ cations, Cl⁻ and phosphate anions and organic acid anions able to form complexes with the Ca²⁺ and Mg²⁺ cations, such as citrate and lactate)

This permeate is carried by a duct 1 to the entrance of a column 2 filled with a strong anionic resin (AF), then from the exit of this column 2 by a duct 3 to the entrance of a column 4 filled with a strong cationic resin (CF).

The strong cationic resin is in the Na⁺ or K⁺ form, i.e. its counter-ion is the Na⁺ or K⁺ ion; the strong anionic resin is in the Cl⁻ form, i.e. its counter-ion is the Cl⁻ ion.

It will be noted that, as an alternative, both these resins could be used in a mixture, in which case a single column would be sufficient.

During the passage of the permeate through the anionic resin, it exchanges its multivalent inorganic anions (phosphate) and organic acid anions (lactate, citrate) with the Cl⁻ ions of the resin; during its passage through the cationic resin, it exchanges its multivalent cations (Ca²⁺, Mg²⁺) with the Na⁺ or K⁺ ions of the resin.

The permeate is therefore relieved from a substantial part of its multivalent cations and multivalent inorganic anions and of its organic acid anions, which cations and anions have been replaced by monovalent cations and anions; this permeate therefore mainly contains lactose, Na⁺, K⁺ and Cl⁻ ions, residual Ca²⁺, Mg²⁺ cations, residual phosphate anions and residual organic acid anions.

The aqueous solution coming from column 4 is then carried by a duct 5 in an evaporation unit 6 of which the function is to concentrate this permeate.

The concentrated permeate coming from unit 6 is then carried by a duct 7 in a crystallization unit 8, where we assist to the crystallization of lactose that is separated from the mother liquor.

This mother liquor very rich in Na⁺, K⁺ and Cl⁻ ions may be, totally or partly, used for the regeneration of the resins respectively filling columns 2 and 4; this regeneration is preferably performed in parallel on these resins, with in this case addition of a make-up NaCl to the mother liquor (see dotted line circuit on the appended figure).

Finally, as an alternative, a part or the totality of said mother liquor can be carried by a duct 9 at the top of a chromatography column 10 of which stems, on one hand, an aqueous solution enriched in residual lactose and, on the other hand, a raffinate enriched in monovalent anions and cations Na⁺, K⁺ and Cl⁻.

This raffinate can also be used for the regeneration of the resins of columns 2 and 4 (see dotted line circuit on appended figure).

In order to demonstrate the importance of this method according to the present invention, it has been compared to the known softening technique by precipitation and centrifugation (centrifugal settling), in the lactose preparation from a permeate of sweet whey, obtained by ultrafiltration of whey.

Two alternatives have been used for the method according to the invention, namely:

use of a cationic resin only (IRA 252 from American company Rohm and Haas)=CF system;

use of an anionic resin (IRA 458 from American company Rohm and Haas), followed in series by a cationic resin (SR1 LNa from company Rohm and Haas)=AF−CF system.

For both these alternatives, the regeneration of the resins is performed by means of the mother liquor coming from the lactose crystallization, respecting the volume ratios: production of 1 volume of mother liquor at 27% of dry matter for 16 volumes of whey permeate at 5.7% of dry matter.

The ionic composition of the permeate is as follows:

| dry matter | Ca²⁺ + Mg²⁺ | Na⁺ + K⁺ | PO₄³⁻ | Cl⁻ |
|---|---|---|---|---|
| (%) | (meq./l) | (meq./l) | (meq./l) | (meq./l) |
| 5.7 | 25 | 52 | 38 | 31 |

Performances of the Systems

| | | | Centrifugal |
|---|---|---|---|
| | CF | AF-CF | settling |
| Ca²⁺ and Mg²⁺ in the | 25 | 25 | 25 |
| permeate to be treated | | | |
| (meq./l) | | | |
| Ca²⁺ + Mg²⁺ in the exit | 4.2 | 1.2 | 6.3 |
| effluent (meq./l) | | | |
| Elimination % of Ca²⁺ + | 83 | 95 | 75 |
| Mg²⁺ | | | |
| Cationic capacity | 0.60 | 0.75 | |
| (eq./l) | | | |

The permeate thus softened is crystallized in order to produce crystallized lactose and a mother liquor containing most of the impurities, including the salts with monovalent ions.

This mother liquor has been clarified by settling and/or filtration before use as resin regenerator. With its pH adjusted to 5, no precipitation has been observed in the resins.

1. Production method of lactose from whey or a permeate resulting from the ultrafiltration of whey, this whey and permeate comprising monovalent Na⁺ and K⁺ cations, monovalent Cl⁻ anions, multivalent Ca²⁺ and Mg²⁺ cations and multivalent inorganic anions, such as phosphate anions and/or organic acid anions able to form complexes with said multivalent cations, such as lactate and citrate, characterized in that it comprises the operations:
(a) of replacement of at least a part of said multivalent cations of the whey or permeate by monovalent metal cations, in order to obtain a whey or permeate depleted in multivalent cations,
(b) of replacement of at least a part of the multivalent inorganic anions and organic acid anions of the whey or permeate by monovalent anions non-able to form complexes with the multivalent cations, this operation (b) being performed either simultaneously to operation (a), in which case a whey or permeate depleted in multivalent inorganic anions, in organic acid anions and in multivalent cations is obtained, or before operation (a), in which case a whey or permeate depleted in multivalent inorganic anions and organic acid anions is obtained, and
(c) of crystallization of said whey or permeate resulting from the preceding operations, and depleted in multivalent inorganic anions, in organic acid anions and in multivalent cations, in order to obtain crystallized lactose and a mother liquor enriched in monovalent metal cations, this crystallization being preceded, if necessary, by an operation of concentration of said whey or permeate to the desired degree.

2. Method according to claim 1, characterized in that it further comprises an operation:
(d) of chromatography of at least a part of the mother liquor obtained during crystallization operation (c), in order to produce a lactose-enriched fraction and a raffinate enriched in monovalent metal cations and possibly in monovalent anions.

3. Method according to claim 2, characterized in that operation (a) of replacement of the multivalent cations comprises the processing of the whey or permeate with a cationic resin of which the counter-ion is a monovalent metal cation.

4. Method according claim 3, characterized in that operation (b) of replacement of the multivalent inorganic anions and organic acid anions comprises the processing of the whey or permeate with an anionic resin of which the counter-ion is a monovalent anion non-able to form complexes with the multivalent cations.

5. Method according to claim 3, characterized in that the monovalent metal cation forming the counter-ion of the cationic resin is the Na⁺ or K⁺ cation.

6. Method according to claim 5, characterized in that the monovalent anion forming the counter-ion of the anionic resin is the Cl⁻ anion.

7. Method according to claim 3, characterized in that it further comprises the operation:
(e) of regeneration of the cationic resin and/or the anionic resin.

8. Method according to claim 7, characterized in that operation (e) of regeneration is performed with a fraction of the mother liquor produced during crystallization operation (c).

9. Method according to claim 8, characterized in that operation (e) of regeneration is performed with a raffinate produced during chromatography operation (d).

10. Method according to claim 9, characterized in that operation (e) of regeneration is performed in series or in parallel on the anionic resin and cationic resin.

11. Method according to claim 1, characterized in that operation (a) of replacement of the multivalent cations comprises the processing of the whey or permeate with a cationic resin of which the counter-ion is a monovalent metal cation.

12. Method according to claim 11, characterized in that operation (b) of replacement of the multivalent inorganic anions and organic acid anions comprises the processing of the whey or permeate with an anionic resin of which the counter-ion is a monovalent anion non-able to form complexes with the multivalent cations.

13. Method according to claim 11, characterized in that the monovalent metal cation forming the counter-ion of the cationic resin is the Na⁺ or K⁺ cation.

14. Method according to claim 13, characterized in that the monovalent anion forming the counter-ion of the anionic resin is the Cl⁻ anion.

15. Method according to claim 11, characterized in that it further comprises the operation:
(e) of regeneration of the cationic resin and/or the anionic resin.

16. Method according to claim 1, characterized in that operation (b) of replacement of the multivalent inorganic anions and organic acid anions comprises the processing of the whey or permeate with an anionic resin of which the counter-ion is a monovalent anion non-able to form complexes with the multivalent cations.
